(19) United States
(12) Patent Application Publication
(10) Pub. No.: US 2003/0190183 A1
(43) Pub. Date: Oct. 9, 2003

(54) Apparatus for connecting fan motor assembly to downrod and method of making same

(76) Inventor: Cheng Ming Hsing, Kaohsiung (CN)

Correspondence Address: SIDLEY AUSTIN BROWN & WOOD LLP, 717 NORTH HARWOOD, SUITE 3400, DALLAS, TX, 75201, US

(21) Appl. No.: 10/116,014

(22) Filed: Apr. 3, 2002

(51) Int. Cl. F16D 1/12; F16C 11/00

(52) U.S. Cl. 403/52

(57) ABSTRACT

A connection device for attaching a downrod to a fan motor assembly of a ceiling fan assembly. The device includes a flange with an aperture defined therein such that a receptacle for receiving a downrod is formed in the flange. The device further includes a sleeve assembly which surrounds at least a portion of the flange, and is capable of projecting into the aperture of the flange. The sleeve assembly can be operated and adjusted to allow a downrod to be inserted and retained in the receptacle bordered by the flange.

### FIELD OF THE INVENTION

The present invention relates to a device for connecting a ceiling fan motor assembly to a downrod.

### BACKGROUND OF THE INVENTION

A downrod is generally used to hang a ceiling fan motor from a position overhead. In general, a first end of the downrod is mounted to a position on a ceiling, and the ceiling fan motor is attached to the second end of the downrod which hangs from the ceiling. Thus, the fan motor is suspended by the second end of the downrod.

Conventionally, the fan motor is attached to the downrod by a combination of screws and pins that lock the downrod into an insert assembly provided on a surface of the fan motor. More specifically, each of the downrod and the insert assembly on the fan motor in which the downrod will be inserted, are provided with corresponding holes which align when the second end of the downrod is positioned in the insert assembly in a predetermined manner. Accordingly, pins and screws can be inserted through the aligned holes of each of the downrod and the insert assembly in order to lock the fan motor onto the hanging downrod.

However, conventional devices for attaching a fan motor to a downrod present difficulty whenever it is necessary to install or remove the fan motor from the downrod. Because corresponding holes of the insert assembly on the fan motor and the downrod must be aligned in order for pins and screws to be inserted through each of the downrod and the insert assembly, the fan motor must be suspended and adjusted until the holes of the downrod and the holes of the insert assembly are aligned. Thus, great effort is required to suspend the fan motor assembly when aligning the insert assembly with the downrod before the fan motor can be secured to the downrod.

### BRIEF SUMMARY OF THE INVENTION

Accordingly, the present invention provides a connection assembly for a fan that facilitates the connection of a downrod to a fan motor of a ceiling fan assembly.

In one aspect of the invention, a device for connecting a downrod to a fan motor assembly comprises a flange having an aperture defined therein, wherein the aperture in the flange is capable of receiving the downrod, and a sleeve assembly surrounding at least a portion of the flange, wherein a portion of the sleeve assembly projects into the aperture when the sleeve assembly is in a first position and retracts from the aperture when the sleeve assembly is in a second position.

In another aspect of the invention, a connection assembly for a fan comprises a downrod having a first end and a second end, a flange provided on a surface of a fan motor assembly, wherein the flange has an aperture defined therein that is capable of receiving the first end of the downrod, and a sleeve assembly surrounding at least a portion of the flange, wherein the first end of the downrod can be retained in the flange when the sleeve assembly is in a first position and the first end of the downrod can be released from said flange when the sleeve assembly is in a second position.

In yet another aspect of the present invention, a method of making a connection device for a fan comprises the steps of providing a flange having an aperture defined therein on a surface of a fan motor, wherein the aperture is capable of receiving a downrod, and positioning a sleeve assembly surrounding at least a portion of the flange, wherein a portion of the sleeve assembly projects into the aperture when the sleeve assembly is in a first position and retracts from the aperture when the sleeve assembly is in a second position.

In a further aspect of the present invention, a sleeve assembly comprises an actuator sleeve, a biasing member, and an adjusting sleeve, wherein the actuator sleeve and the biasing member each surround a portion of the flange, and the adjusting sleeve is provided between the flange and the actuator sleeve.

In yet another aspect of the invention, a projection is provided in a connector and a slot is provided in a downrod, wherein the slot is capable of receiving the tab. Accordingly, the downrod is restricted from rotation while inserted in the connector.

### BRIEF DESCRIPTION OF THE DRAWINGS

Other advantages and features of the invention will become more apparent with reference to the following detailed description of the presently preferred embodiment thereof in connection with the accompanying drawings, wherein like reference numbers have been applied to like elements, in which:

FIG. 1 illustrates a fan assembly according to the one embodiment of the invention;

FIG. 2 illustrates a connection assembly according to the present embodiment of the invention;

FIG. 3 illustrates a cross-sectional view of the connection assembly according to the present embodiment of the invention;

FIG. 4 illustrates a cross-sectional view of the connection assembly according to the present embodiment of the invention; and

FIG. 5 illustrates a cross-sectional view of the connection assembly according to the present embodiment of the invention.

### DETAILED DESCRIPTION OF THE INVENTION

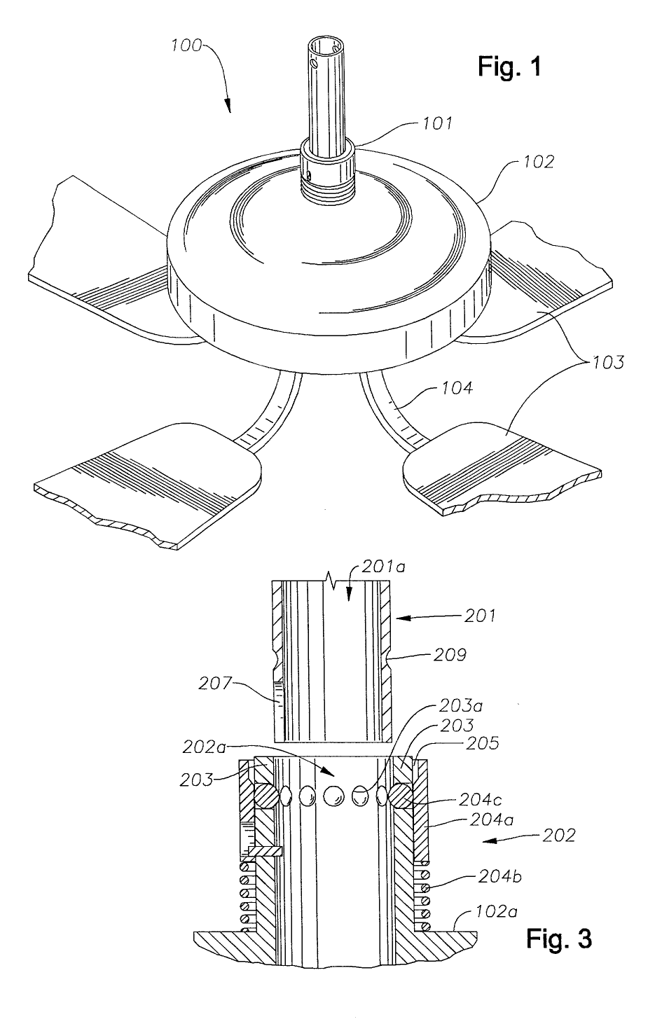

Turning to the drawings, a fan assembly 100 is illustrated in FIG. 1 according to one embodiment of the present invention. As shown, fan assembly 100 includes a connection assembly 101 provided on a motor assembly 102. Fan assembly 100 further includes, a fan blade 103, and a blade arm 104 for attaching fan blade 103 to motor assembly 102.

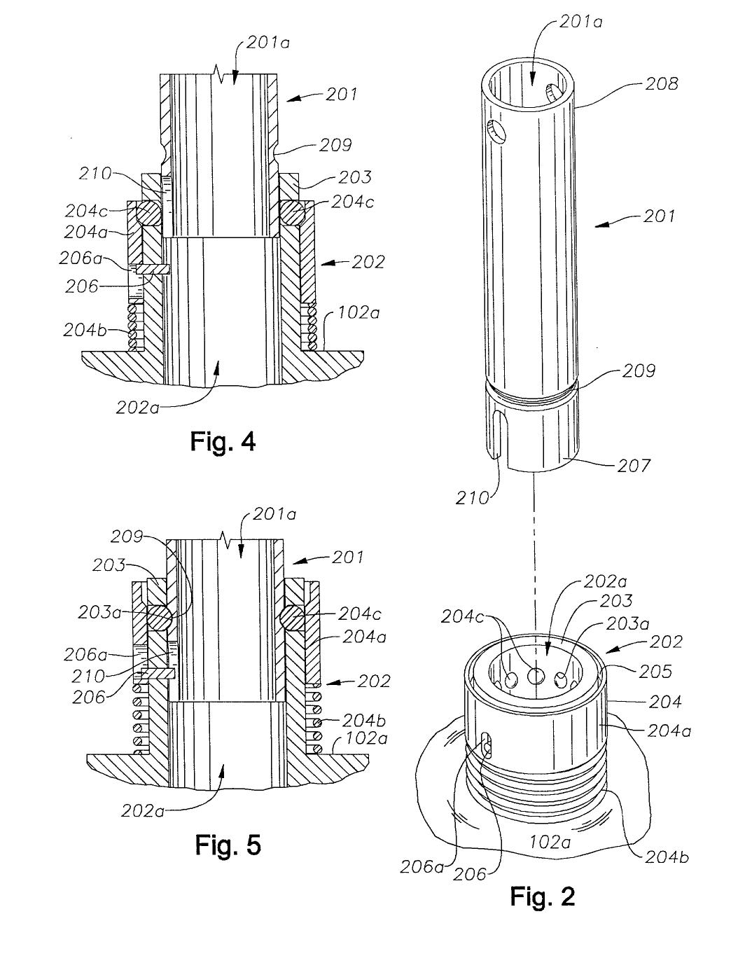

FIG. 2 illustrates the portions of connection assembly 101 in detail. In particular, FIG. 2 illustrates a downrod 201 and a connector 202, each of which will be described in detail hereinafter.

According to the present embodiment, connector 202 includes a flange 203, which extends upwardly, away from motor assembly 102. As shown, flange 203 defines the outer boundaries of an aperture 202a, which runs in a lengthwise direction from a surface 102a of motor assembly 102 upwardly through flange 203.

Connector 202 also includes a sleeve assembly 204 which is formed by an actuator sleeve 204a, a biasing member 204b, and a plurality of spherical members 204cforming an adjusting sleeve. In accordance with the present embodiment, actuator sleeve 204a is a solid ring that is provided in engagement with biasing member 204b, which is in contact with surface 102a of motor assembly 102. As shown in FIG. 2, actuator sleeve 204a is in an uppermost position when biasing member 204b is in a relaxed, or fully expanded state; however, actuator sleeve 204a is capable of traveling along flange 203 in a direction parallel to the length of flange 203 and aperture 202a. Accordingly, biasing member 204b can be compressed according to the amount of travel and the position of actuator sleeve 204a.

Although the present embodiment will be described with reference to an adjusting sleeve formed by a plurality of spherical members 204c, the adjusting sleeve can be of any known configuration, including a single ring, or a plurality of c-shaped rings. Similarly, although actuator sleeve 204a will be described with reference to a ring assembly which can be displaced by a sliding motion, actuator sleeve 204a can be of any configuration, including a threaded member. Likewise, biasing member 204b is not limited to the coil spring type illustrated, and any substitute, including an elastomeric sleeve, can be used without departing from the scope of the invention.

In the present embodiment, the plurality of spherical members 204c are positioned between actuator sleeve 204a and flange 203. As shown, actuator sleeve 204ais in contact with each spherical member 204c such that each spherical member 204c is held against flange 203 and projects into aperture 202a through openings 203a defined in the wall of flange 203. Further, when actuator sleeve 204a is in an uppermost position, as illustrated in FIG. 2, a chamber 205 is provided between actuator sleeve 204a and flange 203, and above the plurality of spherical members 204c.

FIG. 2 also illustrates a projection 206, provided in connector 202, to project from flange 203 inwardly into aperture 202a and outwardly to a position between flange 203 and sleeve assembly 204. Also, according to the present embodiment, actuator sleeve 204a is provided with a guide 206a, in which projection 206 projects. According to the present embodiment, guide 206a is an elongated aperture having a length in a direction that is generally perpendicular to a plane of surface 102a that is greater than a length in a direction that is generally parallel to the plane of surface 102a. As will be explained, the combination of projection 206 and guide 206a aid in controlling the amount of travel in actuator assembly 204. The present description of projection 206 is merely exemplary, and it is understood that projection 206 can be formed by any configuration or shape, and similarly, guide 206a can be any shape that is capable of accommodating projection 206.

FIG. 2 further illustrates downrod 201 which is generally a tubular member having a first end 207 and a second end 208 with an aperture 201a defined therein in a lengthwise direction of downrod 201, i.e., from first end 207 to second end 208, or vice versa. Downrod 201 is further characterized by an indentation 209, which, according to the present embodiment, is an indented ring around the outside of downrod 201 in the vicinity of first end 207. Downrod 201 also includes a slot 210, which begins at a position that is below indentation 209 and extends to the edge of first end 207. In one embodiment of the invention, aperture 201a in downrod 201 and aperture 202a in flange 203 are used to contain electrical wiring to fan motor assembly 102. Although downrod 201 is illustrated and described herein according to a preferred embodiment, downrod 201 can be of any length, size, and shape, as would be appreciated by those skilled in the art.

According to the present embodiment, an inner diameter of flange 203 corresponds with an outer diameter of downrod 201, such that downrod 201 can be inserted into flange 203. The stages of this operation will be now explained with reference to FIGS. 3-5.

FIG. 3 illustrates a cross-sectional view of connection assembly 101 with downrod 201 and connector 202 in a separated state, i.e., before downrod 201 is inserted into connector 202. According to FIG. 3, biasing member 204b is in a relaxed, or expanded state, and accordingly, actuator sleeve 204a is in an uppermost position, with respect to surface 102a. As can be seen, actuator sleeve 204a is positioned to engage spherical members 204c whenever actuator sleeve 204a is in an upwardmost position with respect to surface 102a.

As shown, actuator sleeve 204a narrows at an upper edge thereof forming chamber 205 between flange 203 and actuator sleeve 204a when actuator sleeve 204a is in the upwardmost position. However, when in the upwardmost position, actuator sleeve 204a is formed such that a portion of actuator sleeve 204a engages spherical members 204c. Accordingly, when actuator sleeve 204a is in an upwardmost position with respect to surface 102a, each spherical member 204c is held fixedly in opening 203a.

According to the configuration previously described with respect to FIG. 3, the plurality of spherical members 204c project into aperture 202a in flange 203. The plurality of spherical members 204c projecting into aperture 202a form a ring in flange 203 that has an effective diameter that is less than the outer diameter of downrod 201. Thus, although downrod 201 may be inserted into a portion of connector 202 above the ring formed by the plurality of spherical members 204c, downrod 201 cannot be fully inserted into connector 202 because downrod 201 is unable to slide past the ring formed by the plurality of spherical members 204c.

FIG. 4 illustrates connection assembly 101, wherein downrod 201 is partially inserted in connector 202. As shown, biasing member 204b is in a compressed state, and is displaced in a direction toward surface 102a of motor assembly 102. Correspondingly, actuator sleeve 204a is also displaced to a downwardmost position, in a direction toward surface 102a. Thus, chamber 205, which was formed between actuator sleeve 204a and flange 203, is displaced downwardly in a direction toward surface 102a, such that the new position of chamber 205 corresponds with the position of the plurality of spherical members 204c. More specifically, spherical members 204c are released from their positions in openings 203a by the movement of actuator sleeve 204a in the direction toward surface 102a, and thus, each of the spherical members 204c retract into chamber 205. As shown, in the present embodiment, chamber 205 provides sufficient spacing to accommodate the plurality of spherical members 204c, and therefore, spherical members 204c do not project into aperture 202a. Thus, the effective inner diameter of flange 203 becomes equal throughout the length of aperture 202a, and in particular, the effective inner diameter of flange 203 is now sufficient for downrod 201 to be inserted fully into flange 203. Accordingly, downrod 201 can be inserted into connector 202 past the position of the ring previously formed by the plurality of spherical members 204c, as FIG. 4 shows.

FIG. 4 also illustrates one of the functions of projection 206, according to one embodiment of the present invention. In particular, projection 206 is formed to mate with slot 210 provided in first end 207 of downrod 201. Therefore, in order for first end 207 of downrod 201 to be fully inserted into connector 202, projection 206 and slot 210 must be aligned, as shown in FIG. 4, when first end 207 of downrod 201 is being inserted into connector 201. Thus, projection 206 and slot 210 provide a guide for installing downrod 201 into connector 202.

Further, as can also be seen in FIG. 4, guide 206a, formed in actuator sleeve 204aalso interacts with projection 206. More specifically, projection 206 projects into guide 206a in actuator sleeve 204a such that the amount of travel of actuator sleeve 204a in a direction parallel to flange 203 is limited by the length of guide 206a. Accordingly, when actuator sleeve 204a is displaced in one direction, the movement of actuator sleeve 204a is halted when projection 206 encounters an uppermost wall of guide 206a. Similarly, when actuator sleeve 204a is displaced in a second direction, which is opposite to the first direction, the movement of actuator sleeve 204a is halted when projection 206 encounters a lowermost wall of guide 206a. Thus, projection 206 can be positioned in guide 206awhen actuator sleeve 204a is displaced upwardly and downwardly with respect to surface 102a, and further, the combination of guide 206a and projection 206 can control the amount of upward and downward displacement of actuator sleeve 204a.

FIG. 5 illustrates connection assembly 101 with downrod 201 fully inserted in connector 202. According to FIG. 5, biasing member 204b is returned to a relaxed, or expanded position, and correspondingly, actuator sleeve 204a is returned to an uppermost position, as in FIG. 3. Similarly, the plurality of spherical members 204c are re-positioned in openings 203a in flange 203 such that each spherical member 204 projects into aperture 202a.

Further, the projected portions of each spherical member 204c is now at least partially housed in indentation 209 of downrod 201. More specifically, according to the present embodiment, indentation 209 has a predetermined shape which corresponds with a shape of the ring formed by spherical members 204c. In other words, in the present embodiment, indentation 209 has a contour of a curve in order to receive each spherical member 204c that projects through opening 203a of flange 203. Thus, when downrod 201 is fully inserted into connector 201, and actuator sleeve 204a and biasing member 204b are released to return to a relaxed and upperwardmost position, each spherical member 204c is re-positioned in opening 203a in flange 203, and correspondingly, each spherical member 204c engages indentation 209 in downrod 201 in order to retain, or lock, downrod 201 in flange 203 such that downrod 201 is substantially restrained from movement in a direction parallel to a length of flange 203 . Thus, when downrod 201 is inserted into connector 202, the engagement of the plurality of spherical members 204c with indentation 209 in downrod 201, aid in locking downrod 201 into connector 202. Further, the force of actuator sleeve 204a against the adjusting sleeve formed by the plurality of spherical members 204c also prevents the adjusting sleeve from releasing downrod 201.

Additionally, as shown in FIG. 5, projection 206 is inserted into slot 210 of downrod 201. Thus, projection 206 also aids in locking downrod 201 into connector 202, and in particular, aids in preventing downrod 201 from rotating while positioned in connector 202.

In order to release downrod 201 from the position illustrated in FIG. 5, it is only necessary to move sleeve assembly 204 to the position shown in FIG. 4, wherein the plurality of spherical members 204c do not project into aperture 202a, and more specifically, do not interfere with the movement of downrod 201. Thus, downrod 201 can be removed from flange 203 of connector 202 because downrod 201 is free to move in a direction parallel to the length of flange 203.

In a construction of the presently preferred embodiment of connection assembly 101, flange 203 can be formed with aperture 202a having a predetermined diameter corresponding to a diameter of downrod 201, which is also formed to mate with flange 203. Flange 203 can be provided on surface 102a of motor assembly 102 by any suitable manner including, welding, or a one-piece construction with motor assembly 102. In a similar manner, projection 206 can be provided in flange 203. Thereafter, sleeve assembly 204 can be positioned to surround flange 203 as previously described. Alternatively, flange 203 and sleeve assembly 204 can be formed integrally, then positioned on surface 102a.

Although the present invention has been described with reference to a presently preferred embodiment, it will be appreciated by those skilled in the art that various modifications, alternatives, variations, and substitution of parts and elements, may be made without departing from the spirit of the invention. For example, indentation 209 provided in downrod 201 is not limited to a curved contour as described, but rather, can be of any shape capable of mating with the sleeve assembly 204. Similarly, projection 206, downrod slot 210, and guide 206a can be of any configuration which are capable of mating with each other. Furthermore, connection connector 202 can be constructed with actuator sleeve 204a against surface 102a and biasing member 204b provided thereon, such that the operation described above, in the present embodiment is reversed. Thus, the present application is intended to cover such modifications, alternatives, variations and elements as fall within the scope of the appended claims.

What is claimed is:

1. A device for connecting a downrod to a fan motor assembly comprising:
a flange having an aperture defined therein, said aperture in said flange capable of receiving said downrod; and
a sleeve assembly surrounding at least a portion of said flange, wherein a portion of said sleeve assembly projects into said aperture when said sleeve assembly is in a first position and retracts from said aperture when said sleeve assembly is in a second position.

2. A device according to claim 1 wherein said flange is provided with a projection which projects into said aperture.

3. A device according to claim 1 wherein said flange is provided with a projection which projects into a portion of said sleeve assembly.

4. A device according to claim 3 wherein said projection projects into a guide provided in said sleeve assembly.

5. A device according to claim 1 wherein said sleeve assembly comprises an actuator sleeve, a biasing member, and an adjusting sleeve, wherein said actuator sleeve and said biasing member each surround a portion of said flange, and said adjusting sleeve is provided between said actuator sleeve and said flange.

6. A device according to claim 5 wherein a portion of said adjusting sleeve projects into said aperture when said actuator sleeve is in said first position and retracts from said aperture when said actuator sleeve is in said second position.

7. A device according to claim 5 wherein said adjusting sleeve is formed by a plurality of spherical members.

8. A device according to claim 5 wherein said actuator sleeve can travel in a direction parallel to a length of said flange.

9. A device according to claim 8 wherein said biasing member can be compressed according to a travel amount of said actuator sleeve.

10. A connection assembly for a fan comprising:
a downrod having a first end and a second end;
a flange provided on a surface of a fan motor assembly, said flange having an aperture defined therein that is capable of receiving said first end of said downrod; and
a sleeve assembly surrounding at least a portion of said flange,
wherein said first end of said downrod can be retained in said flange when said sleeve assembly is in a first position and said first end of said downrod can be released from said flange when said sleeve assembly is in a second position.

11. A connection assembly according to claim 10 wherein said flange is provided with a projection which projects into said aperture and said first end of said downrod is provided with a slot in which said projection can be inserted.

12. A connection assembly according to claim 10 wherein in a first position a portion of said sleeve assembly projects into said aperture, and in a second position said portion of said sleeve assembly retracts from said aperture.

13. A device according to claim 10 wherein said flange is provided with a projection which projects into a portion of said sleeve assembly.

14. A device according to claim 13 wherein said projection projects into a guide provided in said sleeve assembly.

15. A connection assembly according to claim 10 wherein said sleeve assembly comprises an actuator sleeve, a biasing member, and an adjusting sleeve, wherein said actuator sleeve and said biasing member each surround a portion of said flange, and said adjusting sleeve is provided between said flange and said actuator sleeve.

16. A connection assembly according to claim 15 wherein a portion of said adjusting sleeve projects into said aperture when said actuator sleeve is in a first position and retracts from said aperture when said actuator sleeve is in a second position.

17. A connection assembly according to claim 15 wherein said adjusting sleeve is formed by a plurality of spherical members.

18. A connection assembly according to claim 15 wherein a portion of said adjusting sleeve can project into an indentation in said downrod when said sleeve assembly is in a first position.

19. A method of making a connection device for a fan comprising the steps of:
providing a flange having an aperture defined therein on a surface of a fan motor, said aperture capable of receiving a downrod; and
positioning a sleeve assembly surrounding at least a portion of said flange,
wherein a portion of said sleeve assembly projects into said aperture when said sleeve assembly is in a first position and retracts from said aperture when said sleeve assembly is in a second position.

20. A method according to claim 19 further comprising the step of providing a projection which extends from said flange into said aperture.

21. A method according to claim 19 further comprising the step of providing a projection which extends from said flange into a portion of said sleeve assembly.

22. A method according to claim 19 wherein said sleeve assembly comprises an actuator sleeve, a biasing member, and an adjusting sleeve, wherein said actuator sleeve and said biasing member each surround a portion of said flange, and said adjusting sleeve is provided between said actuator and said flange.

23. A method according to claim 19 further comprising the step of providing a downrod having a first end and a second end, wherein said first end can be inserted into said aperture in said flange.

24. A method according to claim 23 wherein said first end of said downrod is provided with an indentation therein, said indentation for receiving said portion of said sleeve assembly which projects into said aperture.
